(19) United States
(12) Patent Application Publication
(10) Pub. No.: US 2004/0204781 A1
(43) Pub. Date: Oct. 14, 2004

(54) Antenna device for a wireless device

(75) Inventor: Po-Hsun Hsien, San Chong (TW)

Correspondence Address: Raymond Sun, Law Offices of Raymond Sun, 12420 Woodhall Way, Tustin, CA, 92782, US

(73) Assignee: KYE Systems Corp.

(21) Appl. No.: 10/836,483

(22) Filed: Apr. 30, 2004

Related U.S. Application Data
(63) Continuation-in-part of application No. 09/873,574, filed on Jun. 4, 2001.

(51) Int. Cl. G05B 19/18; G05B 15/00; G09G 5/00

(52) U.S. Cl. 700/84; 700/85; 700/65

(57) ABSTRACT

An antenna device for a wireless device has a transmitter and an antenna. The first connecting end of the transmiter is connected to the first end of the antenna, and the second connecting end of the transmitter is connected to the second end of the antenna. As a result, the antenna device can be formed as a loop and generates a magnetic field for remotely coupling the wireless device to other devices which can receive the signal emitted from the wireless device. The antenna device also includes a resonating and matching circuit coupled to the transmitter or the receiver.

### BACKGROUND OF THE INVENTION

This is a continuation-in-part of co-pending Ser. No. 09/873,574, filed Jun. 4, 2001, entitled “Antenna Device for a Wireless Device”, whose entire disclosure is incorporated by this reference as though set forth fully herein.

1. Field of the Invention

The present invention relates to an antenna device, and in particular, to a low-cost, efficient antenna system for use in a wireless device, such as a keyboard.

2. Description of the Prior Art

Wireless devices are well-known in the art. Non-limiting examples of such wireless devices include a wireless keyboard, a wireless mouse, a wireless joystick, a wireless scanner, a controller for a wireless TV gaming device, a wireless input device for a monitor, and a wireless input device for a data processing mainframe.

Conventional wireless keyboards are normally used in connection with a personal computer. For example, it is well known that wireless infrared keyboards can be used with personal computers. In a wireless infrared keyboard, an infrared transmitter is installed in the keyboard and an infrared receiver is installed in the personal computer so that the keyboard and the personal computer are wirelessly connected for communication. Consequently, no connecting wire is needed between the keyboard and the computer. However, the wireless infrared keyboard suffers from some critical drawbacks. First, the wireless infrared keyboard requires an uninterrupted space between the keyboard and the personal computer for the transmission of the infrared signal from the keyboard to the personal computer (i.e., requires a line-of-sight transmission). As a result, the transferring distance between the keyboard and the personal computer must be finite. If there are obstacles in the transfering path or if the transferring path is too long, then the receiver in the personal computer may not be able to accurately receive the infrared signal emitted from the transmitter of the keyboard. Second, since an infrared keyboard generally requires a DC power source of about six volts (for example, by serially connecting 4 batteries of 1.5 volt), the power consumption can be quite high.

To address the above-described drawbacks of the infrared keyboard, radio frequency (RF) wireless keyboards were provided to overcome the problem posed by obstacles in the transferring path. In addition, RF keyboards have a farther transferring distance, and required less power. However, RF keyboards also suffer from some drawbacks. For example, the general RF keyboard operates in the frequency of 30 MHz (approximately 27 MHz), so that the length of the antenna is positively proportional to the wavelength. Since c (speed of light)=f (Frequency)×(wavelength), therefore for a frequency of 27 MHz, the length of the respective wave is about 11 meters, so that the length of the antenna would need to be about 6 meters (for a half wave coupler antenna), which is prohibitively long for many applications.

To address this drawback with RF keyboards, U.S. Pat. No. 6,138,050 to Schneider et al. discloses an antenna system and a device for use in an RF keyboard. FIGS. 1-4 illustrate the keyboard and system described in U.S. Pat. No. 6,138,050 to Schneider et al.

FIG. 1 illustrates a data processing system 101 in accordance with U.S. Pat. No. 6,138,050. The data processing system 101 includes a processor system 110 having a central processing unit (“CPU”) 115, a radio-frequency (“RF”) receiver subsystem 120, an input device subsystem 130a and a video subsystem 135a that are all coupled to a data bus 140. In addition, the data processing system 101 includes a mouse 130b, a video monitor 135b and an RF wireless keyboard 125. The input device subsystem 130a is coupled with an input device (e.g., the mouse 130b). The video subsystem 135a is coupled to a video system (e.g., the video monitor 135b). The RF receiver subsystem 120 is coupled to an RF input device (e.g., the wireless keyboard 125).

The RF receiver subsystem 120 may be a mono receiver or may be a multiple receiver. That is, the RF receiver subsystem 120 may be coupled via RF with the wireless keyboard 125 alone or with the wireless keyboard 125 and other RF transmitting devices (e.g., RF wireless mouse). The RF receiver subsystem 120 may also be a standalone-type device that may be coupled to, but is located external to, the processor system 110.

During the operation of the data processing system 101, the wireless keyboard 125 transfers RF signals representing particular keys of the keyboard 125 to the RF receiver system 120. The RF receiver system 120 converts the RF signals to the appropriate key character and passes the key character to the CPU 115 for processing.

FIG. 2 is an external diagram of one embodiment of the wireless keyboard 125 in accordance with the invention in U.S. Pat. No. 6,138,050. The wireless keyboard 125 has a housing 210 and a keycap subsystem 215 that includes one or more keycaps 215a. The housing 210 may be composed of a plastic, for example an injection molded thermopastic or other similar material. Further, the keycaps 215a may also be composed of a thermoplastic material. The keyboard function of the wireless keyboard 125 may be functionally and structurally similar to commercially available keyboards, such as a 101-key keyboard from IBM Corporation of Armonk, N.Y., a wave keyboard from Microsoft Corporation, of Redmond, Wash., or a membrane-type keyboard. In addition, the dimensions of the wireless keyboard 125 may be approximately 46 centimeters by 18 centimeters by 3 centimeters.

FIG. 3a is a diagram of internal structural components of a keyswitch system of the wireless keyboard 125. The keyswitch system includes a keyswitch pad 310, a keyswitch printed circuit membrane (“keyswitch PCM”) subsystem 315 that includes one or more keyswitch printed circuit membranes, and a metallic plate 320. The keyswitch pad 310 includes keyswitches that are membrane keyswitches or mechanical keyswitches. The keyswitch PCM subsystem 315 may be substituted with a keyswitch printed circuit board (“keyswitch PCB”) that may be constructed to incorporate the metallic plate 320, for example as a thin copper film. The keyswitch pad 310 and the keyswitch PCM subsystem 315 may be comprised of a lightweight flexible plastic or other similar material. The metallic plate 320 may be comprised of a metallic material that may be flexible or substantially rigid and may have dimensions of 40 centimeters by 15 centimeters, for example. The keyswitches can be membrane keyswitches or mechanical keyswitches. Each keyswitch is associated with a particular keycap 215a that is, in turn, associated with a particular character or function on the wireless keyboard 125.

The keyswitch pad 310 is coupled to the keyswitch PCM subsystem 315. The combination of the keyswitch pad 310 and keyswitch PCM subsystem 315 is coupled to the metallic plate 320, which provides structural rigidity for the keyswitch system of the wireless keyboard 125. The metallic plate 320 also protects the keyswitch PCM subsystem 315 against electrostatic discharge. In addition, the keyswitch PCM subsystem 315 includes a series of electrical contacts. Each electrical contact is in an open position until closed by a particular keyswitch. A keyswitch closes the electrical contact when the associated keycap 215a is depressed by a user. The RF wireless keyboard 125 transmits an RF signal representing the character or function associated with the particular keycap 215a and keyswitch via the RF transmitter PCB 410 to the RF receiver subsystem 120.

FIG. 3b is a block diagram of an RF transmitter printed circuit board (“RF transmitter PCB”) 410, or alternatively an RF transmitter printed circuit membrane (“RF transmitter PCM”), in accordance with U.S. Pat. No. 6,138,050. The RF transmitter PCB 410 generates RF signals for transmission to the receiver subsystem 120. The RF transmitter PCB 410 includes a digital processing circuit 350, a low-power RF transmitter circuit 360, and two output terminals. One output terminal is an electrical ground 370 of the transmitter PCB 410. The digital processing circuit 350 is coupled to the RF transmitter circuit 360.

The digital processing circuit 350 includes a keyswitch scanner subsystem 352 and a keyswitch encoder subsystem 354. The RF transmitter circuit 360 includes a modulator subsystem 362 and may also include an amplifier subsystem 364. The scanner subsystem 352 is coupled to the keyswitch PCM subsystem 315 and the keyswitch encoder subsystem 354. The keyswitch encoder subsystem 354 is coupled to the modulator system 362. The modulator subsystem 362 is coupled to the amplifier subsystem 364. The RF transmiter circuit 360 is coupled to the RF antenna system 401 described in FIG. 4.

During operation of the wireless keyboard 125, the scanner subsystem 352 scans the keyswitch PCM subsystem 315 to detect a closed electrical contact as a result of a depressed keycap 215a. Once detected, the keyswitch encoder subsystem 354 generates an encoded data signal associated with a character or function of the depresssed keycap 215a. The encoded data signal is modulated by the modulator subsystem 362 so that it may be transmitted as an RF signal. The RF signal may also be amplified by the amplifier subsystem 364 before transmission by the RF antenna system 401. The RF transmitter PCB 410, as well as the other electrical systems within the RF wireless keyboard 125, may be powered by a battery supply, such as two 1.5 volt alkaline or nickelcadium batteries.

FIG. 4 illustrates the RF antenna system 401 utilized by U.S. Pat. No. 6,138,050 to avoid the drawbacks of conventional RF keyboards. The RF antenna system 401 includes the metallic plate 320, an antenna wire 415 and a connector wire 420. The RF antenna system 401 may include the RF transmitter PCB 410. The antenna wire 415 is coupled at a first end to an output of the amplifier subsystem 364 of the RF transmitter PCB 410, and is coupled at a second end to a first end or section of the metallic plate 320. A second end or section of the metallic plate 320 is coupled, through the connector wire 420, to a second output of the amplifier subsystem 364, which may be ground 370 of the RF transmitter PCB 410. The antenna wire 415 and the metallic plate 320 form an antenna loop that is coupled to the outputs of the amplifier subsystem 364 of the RF transmitter PCB 410. The antenna loop generates a magnetic field from which the RF signals from the RF transmitter circuit 360 are transmitted to the receiver subsystem 120 in accordance with electromagnetic propagation principles.

Unfortunately, the metallic board 320 presents a drawback because of its weight and size. Since the current trend is for keyboards that are light-weight, and which have a thin and compact design, the metallic board 320 can be an undesirable feature.

In addition, the conventional loop antenna typically includes capacitors and inductors that function to resonate frequency (i.e., forming a resonating circuit) at about 27 MHz so as to apply the loop antenna to multi-channels. The FCC provides sixteen channels at 27 MHz, so conventional transmitters and receivers can transmit and receive wireless signals through any of these sixteen channels. Unfortunately, these conventional loop antennas still experience interference from wireless signals from other adjacent channels.

Therefore, there still remains a need for a wireless keyboard, and other wireless devices, which avoid the drawbacks described above.

### SUMMARY OF THE DISCLOSURE

It is an object of the present invention to provide an antenna device for a wireless device.

It is another object of the present invention to provide an antenna device that is light-weight and does not take up much space.

It is yet another object of the present invention to provide an antenna device that does not require high power consumption.

It is yet another object of the present invention to provide an antenna device that can communicate signals without the need for line-of-sight transmission.

It is yet a further objective of the present invention to provide an antenna device that minimizes interference from wireless signals from other adjacent channels.

It is yet a further objective of the present invention to provide an antenna device that reduces the adjacent channel power (ACP) at a transmitter and reduces the adjacent channel rejection (ACR) at a receiver.

It is yet a further objective of the present invention to provide an antenna device that reduces the ACP and the ACR at a transceiver.

In order to accomplish the objects of the present invention, the present invention provides an antenna device for a wireless device. The antenna device is installed within the wireless device and has a transmitter and an antenna. The first connecting end of the transmiter is connected to the first end of the antenna, and the second connecting end of the transmitter is connected to the second end of the antenna. As a result, the antenna device can be formed as a loop and generates a magnetic field for remotely coupling the wireless device to other devices which can receive the signal emitted from the wireless device. The antenna device can also include a resonating and matching circuit coupled to the transmitter or the receiver.

### BRIEF DESCRIPTION OF THE DRAWINGS

FIGS. 1, 2, 3a, 3b and 4 illustrate a prior art antenna system for a wireless keyboard.

FIG. 5 is a schematic view of an antenna according to one embodiment of the present invention implemented with a wireless keyboard.

FIG. 6 is a schematic view of an antenna according to another embodiment of the present invention implemented with a wireless keyboard.

FIG. 7 is a schematic view of an antenna according to another embodiment of the present invention implemented with a controller of a TV gaming device.

FIG. 8 is a schematic view of an antenna according to another embodiment of the present invention implemented with a data processing mainframe of a personal computer.

FIG. 9 is a schematic view of an antenna according to another embodiment of the present invention implemented with a monitor or similar display device.

FIG. 10 is a circuit diagram of a resonating and matching circuit according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides an antenna device for a wireless device, such as a keyboard. The antenna device is installed within the wireless device and has a transmitter and an antenna. The first connecting end of the transmitter is connected to the first end of the antenna, and the second connecting end of the transmitter is connected to the second end of the antenna. As a result, the antenna device can be formed as a loop which generates a magnetic field for remotely coupling the wireless device to other devices which can receive the signal emitted from the wireless device.

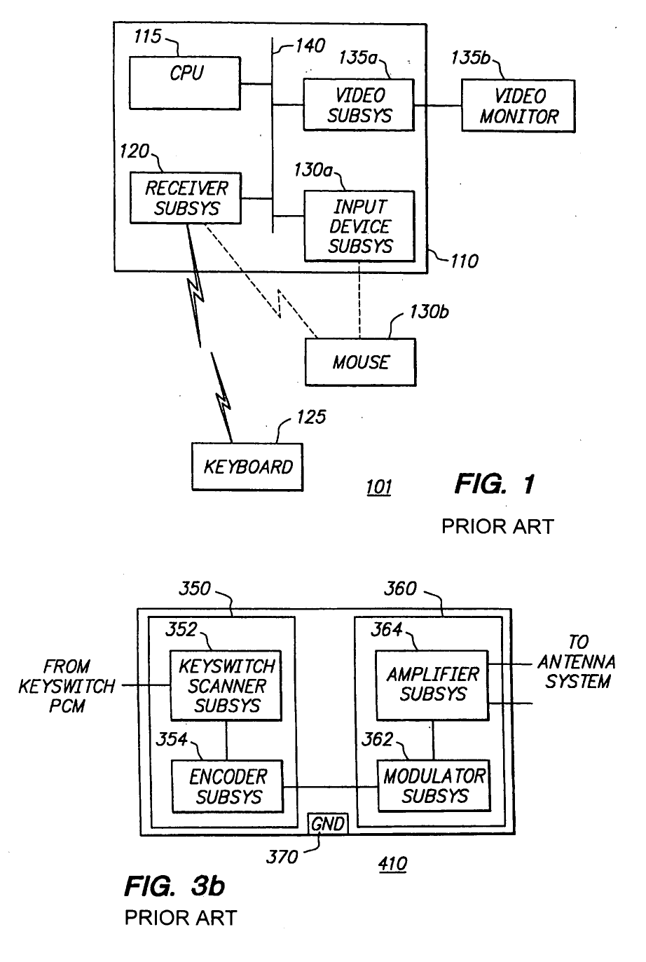

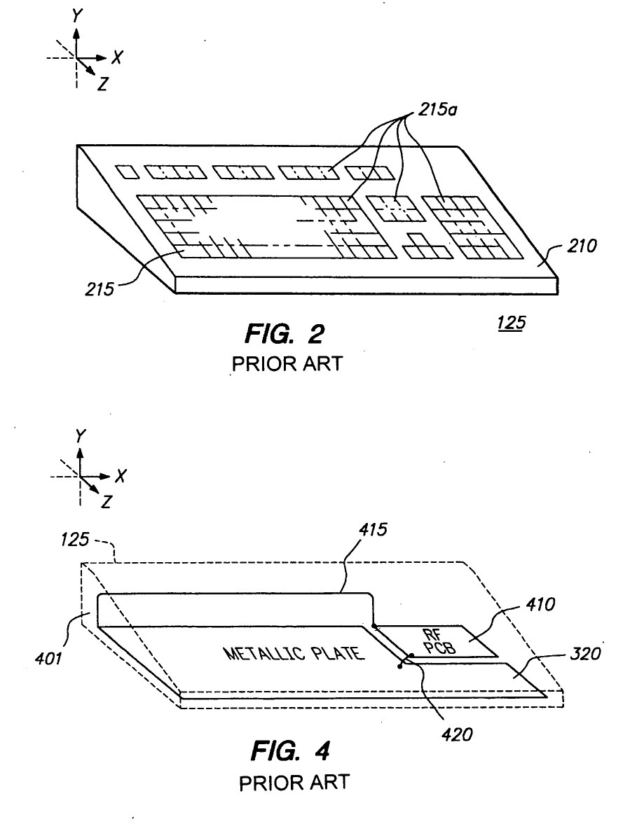

FIG. 5 illustrates a wireless keyboard 10 embodying an antenna device according to the one embodiment of the present invention. The antenna device of the wireless keyboard 10 has a transmitter 13 and an antenna 14. The antenna 14 is arranged within the wireless keyboard 10, which can have the same structural components as those illustrated in FIGS. 1, 2, 3a and 3b above. Here, the transmitter 13 can be the same as the RF transmitter PCB 410 described above. One end of the antenna 14 is connected (e.g., by soldering) to a first connecting end of the transmitter 13, and the other end of the antenna 14 connected (e.g., by soldering) to a second connecting end of the transmitter 13. As a result, the antenna 14 and the transmitter 13 are formed as a loop for generating a magnetic field 18. The antenna 14 can be positioned under the printed circuit membrane (e.g., PCM 315), or can be positioned in a portion of the interior of the keyboard 10 such that the length of the antenna 14 is greater than the combined length of all four sides of the PCB. For example, the antenna 14 can be positioned about the internal periphery of the keyboard 10, as shown in FIG. 5, and can assume the rectangular configuration of the keyboard 10.

By omitting the use of the metallic plate 320, the antenna device of the present invention allows the wireless device to be provided in a more compact configuration since the antenna device imposes fewer space constraints. Therefore, the magnetic field 18 of the present invention can be enlarged so that the wireless keyboard 10 can be wirelessly coupled to other devices, such as a personal computer, etc. In addition, positioning the antenna 14 in an interior portion of the keyboard 10 such that the length of the antenna 14 is greater than the combined length of all four sides of the PCB allows the length of the antenna 14 to be increased, thereby improving antenna gain.

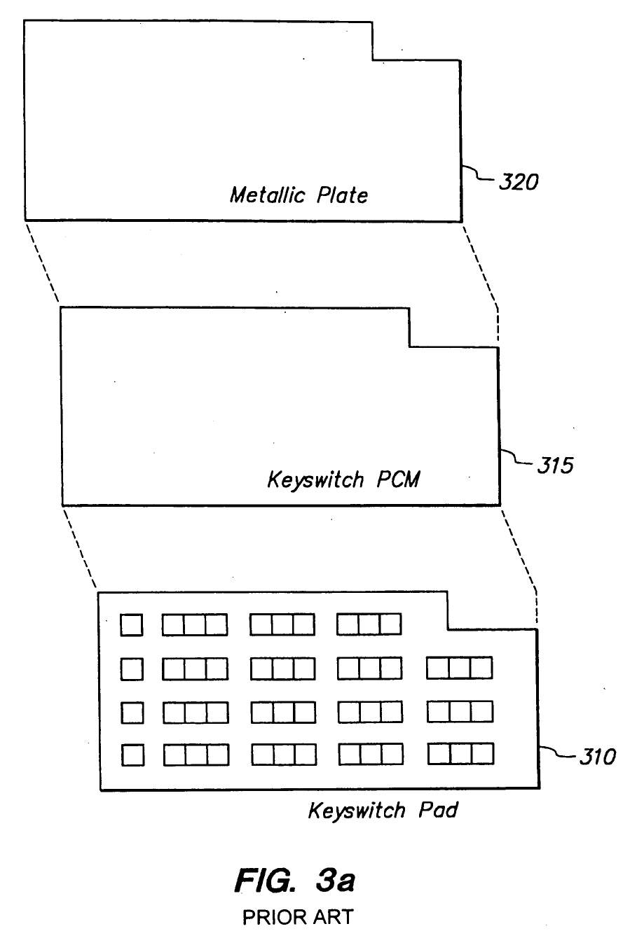

FIG. 6 illustrates an antenna device according to another embodiment of the present invention as incorporated in a wireless device 20 (which can be a keyboard). In the wireless device 20, the antenna device has a transmitter 23 and an antenna 24. The antenna 24 is arranged within the wireless device 20, with one end of the antenna 24 connected to a first connecting end of the transmitter 23, and the other end of the antenna 24 connected to a second connecting end of the transmitter 23. In addition, a noise blocker 5 can be included, which is connected to a third connecting end of the transmitter 23 through a connecting wire 41. The noise blocker can be implemented in the form of a metallic plate (e.g., such as 320), and functions to block outside noise from entering the keyboard 10 to prevent interference from other devices. The size of the noise blocker 5 is not limited, and can be provided in any desired size to suit the intended application.

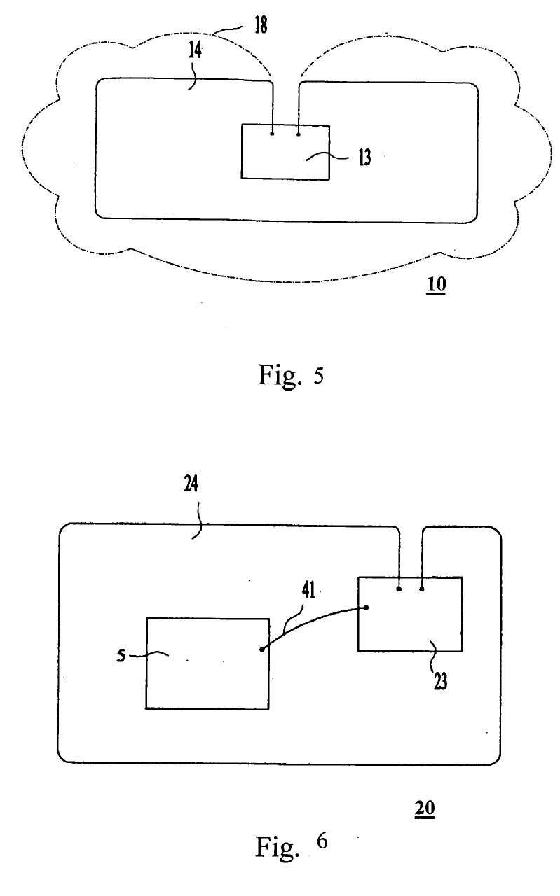

FIG. 7 illustrates the principles of the present invention (from FIGS. 5 and 6 above) as applied to a wireless TV game device 30. One end of the antenna 34 is connected to a first connecting end of the transmitter 33 (shown in phantom), and the other end of the antenna 34 is connected to a second connecting end of the transmitter 33. The antenna 34 extends inside the housing 6 of the device 30 along the irregular shape of the housing 6 so as to be formed as a loop with the transmiter 33. The transmitter 33 can also be provided inside the housing 6.

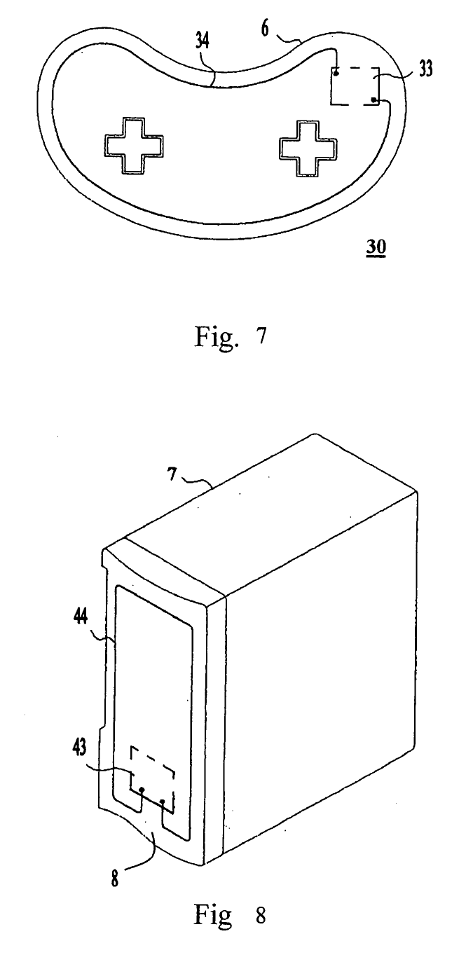

FIG. 8 illustrates the principles of the present invention (from FIGS. 5 and 6 above) as applied to the data processing mainframe 7 of a wireless personal computer. One end of the antenna 44 is connected to a first connecting end of the transmitter 43, and the other end of the antenna 44 is connected to a second connecting end of the transmitter 43. The antenna 44 and transmitter 43 can be positioned inside the front panel 8 of the mainframe 7. It is noted that element 43 can also be a receiver.

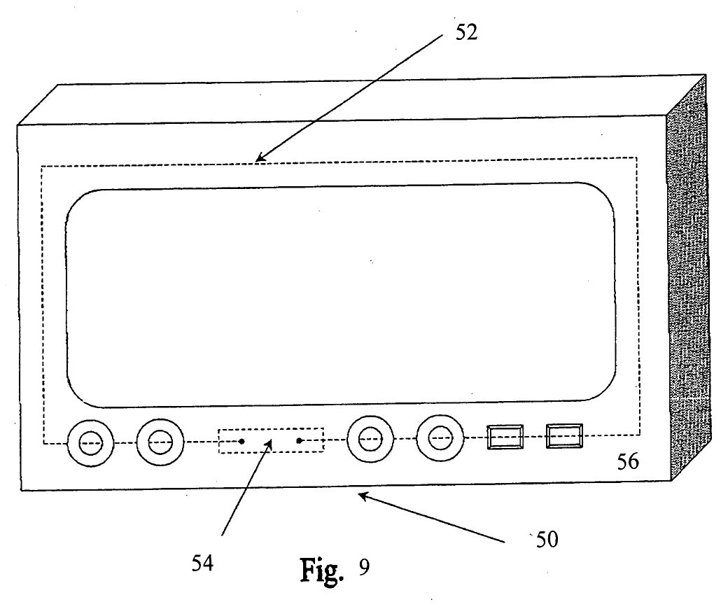

FIG. 9 illustrates the principles of the present invention (from FIGS. 5 and 6 above) as applied to a monitor or similar display device 50 (e.g., CRT or TFT LCD) of a personal computer. One end of the antenna 52 is connected to a first connecting end of the transmitter 54, and the other end of the antenna 52 is connected to a second connecting end of the transmitter 54. The antenna 52 and transmitter 54 can be positioned inside the front panel 56 of the display device 50. It is noted that element 54 can also be a receiver.

As described herein, the antenna of the present invention is positioned within the wireless device, and does not incorporate a metallic plate as part of the antenna loop. Therefore, the antenna can be made thinner and can be hidden within a small-sized wireless device. In addition, the antenna of the present invention can be wound as desired and thus a larger and omnidirectional magnetic field can be generated. Furthermore, the antenna of the present invention is flexible and can be used in applications appropriate for a flexible or stacked antenna. The antenna of the present invention minimizes power consumption because the antenna provides efficient and effective radiation in both horizontal polarizarion and vertical polarization. The antenna of the present invention can also be arranged in the wireless device in a manner to be hidden in the wireless device to prevent the antenna from being stolen or destroyed.

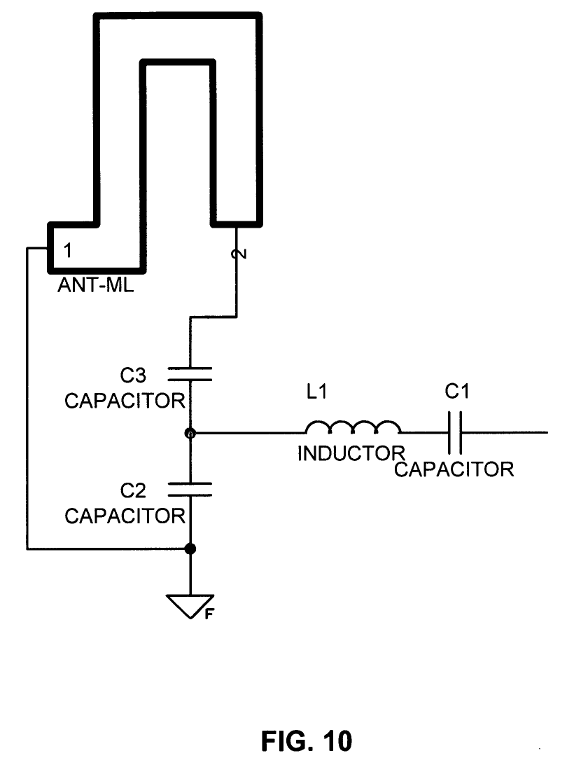

FIG. 10 illustrates a resonating and matching circuit that can be used with the antenna 14 of FIG. 5 at a transmitter end, a receiver end or a transceiver end for sending or receiving wireless signals according to transmission principles that are well-known to those skilled in the art. The resonating and matching circuit is connected to the transmitter 13 in FIG. 5, or the receiver 43 in FIGS. 8 and 9. The resonating and matching circuit includes two capacitors C2 and C3 connected in parallel, and a capacitor C1 and inductor L1 connected in series. The resonating and matching circuit provides impedance resistance, and also reduces the adjacent channel power (ACP) at the transmitter end (e.g., 13) and reduces the adjacent channel rejection (ACR) at the receiver end (e.g., 43). By reducing the ACP and the ACR, the antenna 14 can receive and send wireless signals through a single specific channel.

For example, at the transmitter end (e.g., 13), an input signal can be resonated by capacitor C1 and inductor L1, and further resonated by the capacitors C2, C3 and the antenna 14, according to principles that are well-known to those skilled in the art. As a result, the ACP can be restrained or reduced such that the gain ratio of the primary frequency and critical frequency can be effectively controlled. In other words, the wireless input signal can be transmitted through a specific channel, and will not interfere with the other signals in the other channels.

Similarly, at the receiver end (e.g., 43), a received wireless input signal can be resonated by the capacitors C2, C3 and the antenna 14, and further resonated by the capacitor C1 and the inductor L1, using principles that are well-known to those skilled in the art. As a result, the ACP can be restrained or reduced such that the wireless input signal can be received through a specific channel, and will not interfere with the other signals in the other channels.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A wireless keyboard, comprising:
a transmitter having a first connecting end and a second connecting end;
an antenna having a first end connected to the first connecting end, and a second end connected to the second connecting end, in a manner to form a loop; and
a resonating and matching circuit coupled to the transmitter and including:
first and second capacitors connected in parallel to each other; and
a third capacitor and an inductor connected in series and to the first and second capacitors.

2. The device of claim 1, wherein the transmitter has a third connecting end, and further including a noise blocker coupled to the third connecting end.

3. The device of claim 1, wherein the keyboard has a periphery, and wherein the antenna is provided along the periphery of the keyboard.

4. A wireless keyboard, comprising:
a PCB;
a transmitter coupled to the PCB and having a first connecting end and a second connecting end;
an antenna having a first end connected to the first connecting end, and a second end connected to the second connecting end, in a manner to form an antenna loop that extends away from the PCB; and
a resonating and matching circuit coupled to the transmitter and including:
first and second capacitors connected in parallel to each other; and
a third capacitor and an inductor connected in series and to the first and second capacitors.

5. The device of claim 4, wherein the PCB has four sides that define a combined length, and wherein the antenna loop has a length that is greater than the combined length.

6. The device of claim 4, wherein the keyboard has a periphery, and wherein the antenna is provided along the periphery of the keyboard.

7. A resonating and matching circuit that is coupled to a PCB of a wireless antenna for a computer peripheral device, the circuit comprising:
first and second capacitors connected in parallel to each other; and
a third capacitor and an inductor connected in series and to the first and second capacitors.

8. The circuit of claim 7, wherein the computer peripheral device is a wireless input device that sends wireless signals to a wireless receiver.

9. The circuit of claim 7, wherein the computer peripheral device is a wireless receiver that receives wireless signals from a wireless input device.

10. A wireless computer peripheral device, comprising:
a PCB;
a wireless signal processor coupled to the PCB and having a first connecting end and a second connecting end;
an antenna having a first end connected to the first connecting end, and a second end connected to the second connecting end, in a manner to form an antenna loop that extends away from the PCB; and
a resonating and matching circuit coupled to the processor and including:
first and second capacitors connected in parallel to each other; and
a third capacitor and an inductor connected in series and to the first and second capacitors.

11. The device of claim 10, wherein the PCB has four sides that define a combined length, and wherein the antenna loop has a length that is greater than the combined length.

12. The device of claim 10, wherein the PCB has a periphery, and wherein the antenna is provided along the periphery of the PCB.

13. The device of claim 10, wherein the wireless signal processor is a receiver.

14. The device of claim 10, wherein the wireless signal processor is a transmitter.
